(19) United States
(12) Patent Application Publication
(10) Pub. No.: US 2006/0098651 A1
(43) Pub. Date: May 11, 2006

(54) Method and system for managing IP address assigned to mobile station

(76) Inventor: Han-jin Joh, Incheon (KR)

Correspondence Address: CANTOR COLBURN, LLP, 55 GRIFFIN ROAD SOUTH, BLOOMFIELD, CT, 06002, US

(21) Appl. No.: 11/266,114

(22) Filed: Nov. 3, 2005

(30) Foreign Application Priority Data
Nov. 5, 2004 (KR) 10-2004-0089936
Sep. 23, 2005 (KR) 10-2005-0088765

(51) Int. Cl. H04L 12/56

(52) U.S. Cl. 370/389

(57) ABSTRACT

A method and system for managing an IP address assigned to a mobile station which can be executed in a PDSN or an IWF is provided. When the mobile station is not determined to have used an actual IP address in a dormant state for a certain time period, the actual IP address assigned to the mobile station is repossessed and a virtual IP address is assigned. When the system receives a packet data service request from the mobile station assigned the virtual IP address, the system repossesses the virtual IP address assigned to the mobile station and assigns an actual IP address to the mobile station. The method includes: determining whether a mobile station uses an actual IP address in a dormant state for a certain time period; and repossessing the actual IP address assigned to the mobile station and assigning a virtual IP address by a PDSN or an IWF.

### BACKGROUND OF THE INVENTION

This application claims the priorities of Korean Patent Application Nos. 2004-89936, filed on Nov. 5, 2004, and 2005-88765, filed on Sep. 23, 2005, in the Korean Intellectual Property Office, the disclosures of which are incorporated herein in their entireties by reference.

1. Field of the Invention

The present invention relates to a method and system for managing an Internet Protocol (IP) address assigned to a mobile station and, more particularly, to a method and system for managing an IP address assigned to a mobile station, which is capable of repossessing an IP address not used by the mobile station in a dormant state for a certain time period so that waste of IP address resources can be prevented.

2. Description of Related Art

A wireless IP-based mobile station is assigned an IP address from a mobile communication system via the Point-to-Point Protocol (PPP)/Internet Protocol Control Protocol (IPCP) to use packet data services when the packet data services are available.

Since it takes a certain time period for a mobile station to make a PPP connection, it is not efficient that the PPP connection has to be made to be assigned an IP address each time data packets are transmitted/received by the mobile station in a dormant state. Accordingly, when a user does not transmit/receive data packets for a certain time period, the mobile station typically disconnects a radio channel while maintaining an IP address. When the user tries to receive data packets, the mobile station connects the radio channel again to allow the user to use data services through TCP or UDP/IP-based socket communication.

However, there is a problem in that if the IP address remains assigned to the mobile station even during the dormant state, it causes waste of IP address resources.

### SUMMARY OF THE INVENTION

The present invention provides a method and system for managing an IP address assigned to a mobile station so that the IP address can be repossessed when it is not used by the mobile station in a dormant state for a certain time period.

According to an aspect of the present invention, there is provided a system for managing an IP (Internet Protocol) address assigned to a mobile station which can be executed in a PDSN (Packet Data Serving Node) or an IWF (InterWorking Function), wherein when the mobile station is not determined to have used an actual IP address in a dormant state for a certain time period, the actual IP address assigned to the mobile station is repossessed and a virtual IP address is assigned for protocol maintenance.

When the system receives a packet data service request from the mobile station assigned the virtual IP address, the system may repossess the virtual IP address assigned to the mobile station and assign an actual IP address to the mobile station.

When the mobile station assigned the virtual IP address moves to a new PDSN area or a new IWF area such that a handoff process is performed, a new PDSN or a new IWF located in the new PDSN area or the new IWF area may receive information concerning the virtual IP address assigned to the mobile station from an old PDSN or an old IWF and register the received information.

According to another aspect of the present invention, there is provided a system for managing an IP address assigned to a mobile station having a PDSN execution module or an IWF execution module including: an IP usage detection unit detecting whether or not a mobile station uses an actual IP address in a dormant state for a certain time period; an IP assignment unit repossessing the actual IP address from the mobile station and assigning a virtual IP address to the mobile station for protocol maintenance when the mobile station is not determined to have used the actual IP address in the dormant state for a certain time period; and an IP assignment info storage unit storing and registering information concerning the IP address assigned by the IP assignment unit in a database.

The system may further include a packet data service request info receiving unit which receives a packet data service request from the mobile station assigned the virtual IP address, wherein the IP assignment unit may further repossess the virtual IP address assigned to the mobile station and assign an actual IP address to the mobile station.

When the mobile station assigned the virtual IP address moves to a new PDSN area or a new IWF area such that a handoff process is performed between the PDSNs or the IWFs, the IP assignment info storage unit may receive information concerning the virtual IP address assigned to the mobile station from an old PDSN or an old IWF and register the received information.

The IP usage detection unit may detect whether or not the mobile station uses an actual IP address in a dormant state for a certain time period by monitoring the number of times a BSC (Base Station Controller) of a mobile communication system updates the actual IP address assigned to the mobile station in the dormant state of the mobile station after a predetermined time period.

Information concerning the virtual IP address assigned by the IP assignment unit may be transmitted to the mobile station through an Overhead Message.

The IP assignment unit may further assign the repossessed actual IP address to a mobile station of a new user.

The time period counted to repossess the actual IP address assigned to the mobile station may be selected by a user.

The system may further include a mobile station execution module which sets the time period counted to assign the virtual IP address after repossessing the actual IP address in the dormant state of the mobile station, and transmits the set time period to the PDSN execution module or the IWF execution module.

The mobile station execution module may provide a frequency menu that represents the use frequency of packet data services to a user so that the user can select the use frequency of packet data services, and set the time period according to the use frequency selected from the user.

According to another aspect of the present invention, there is provided a method of managing an IP address assigned to a mobile station, the method including the operations of: determining whether or not a mobile station uses an actual IP address in a dormant state for a certain time period; and repossessing the actual IP address assigned to the mobile station and assigning a virtual IP address for protocol maintenance by a PDSN or an IWF when the mobile station is not determined to have used the actual IP address in the dormant state for the time period.

The method may further include the operations of: receiving, by the PDSN or the IWF, a packet data service request from the mobile station assigned the virtual IP address; and repossessing, by the PDSN or the IWF, the virtual IP address assigned to the mobile station and assigning an actual IP address to the mobile station in response to the packet data service request.

The method may further include the operation of receiving, by a new PDSN or a new IWF, information concerning the virtual IP address assigned to the mobile station from an old PDSN or an old IWF and registering the received information when the mobile station moves to a new PDSN area or a new IWF area such that a handoff process is performed between the PDSNs or the IWFs.

The operation of determining may determine whether or not the mobile station uses the actual IP address in the dormant state for a certain time period by monitoring the number of times a BSC of a mobile communication system updates the actual IP address assigned to the mobile station after a predetermined time period in the dormant state of the mobile station.

Information concerning the virtual IP address assigned in the operation of repossessing the actual IP address and assigning a virtual IP address may be transmitted to the mobile station through an Overhead Message.

The repossessed actual IP address may be assigned to a mobile station of a new user.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mobile communication system; and

FIG. 2 is a block diagram of an IP address management system in accordance with an embodiment of the present invention;

FIG. 3 is a flow chart of a method of managing an IP address assigned to a mobile station in accordance with another embodiment of the present invention;

FIG. 4 is a block diagram of an IP address management system in accordance with another embodiment of the present invention; and

FIG. 5 is a flow chart of a method of managing an IP address assigned to a mobile station in accordance with another embodiment of the present invention.

### DETAILED DESCRIPTION OF THE INVENTION

Exemplary embodiments in accordance with the present invention will now be described in detail with reference to the accompanying drawings.

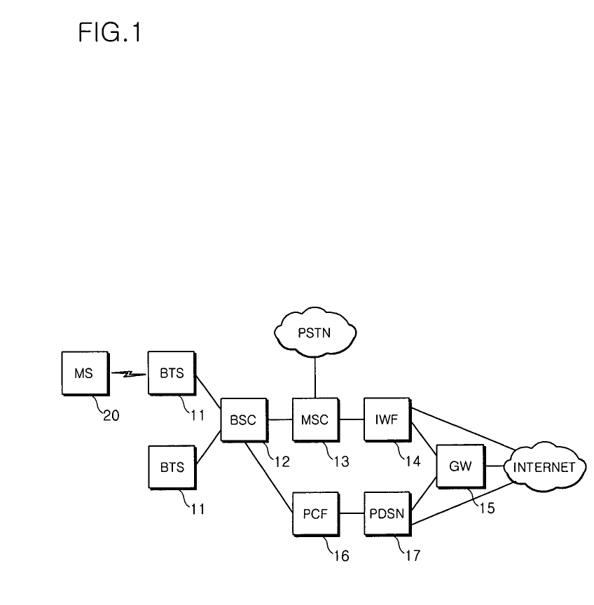

FIG. 1 is a block diagram of a mobile communication system. The mobile communication system includes a Base Transceiver Station (BTS) 11, a Base Station Controller (BSC) 12, a Mobile Switching Center (MSC) 13, an InterWorking Function (IWF) 14, a gateway (GW) 15, a Packet Control Function (PCF) 16, and a Packet Data Serving Node (PDSN) 17.

The BTS 11 transmits/receives voice or data to/from a Mobile Station (MS) 20. The BSC 12 is responsible for traffic resource allocation to the MS 20, and the exchange of messages towards the MSC 13 and the BTS 11. The MSC 13 is a telephone exchange which provides circuit-switched calling and mobility management to the MS 20 roaming within an area that it serves. The IWF 14 and the GW 15 are provided between a mobile communication network and the Internet to offer circuit switched data service and packet data service to mobile users. The PCF 16 controls the transmission of packets between the BSC 12 and the PDSN 17. The PDSN 17 is responsible for the establishment, maintenance and termination of a PPP (Point-to-Point Protocol) session towards the MS 20 and may also assign dynamic IP addresses.

According to the present invention, when a mobile station in a dormant state is not determined to have used an actual IP address for a certain time period, the actual IP address assigned to the mobile station is repossessed and a virtual IP address is assigned to the mobile station to maintain protocol, thereby preventing waste of IP address resources.

Meanwhile, when the mobile station assigned the virtual IP address requests a packet data service, the virtual IP address is repossessed and an actual IP address is assigned to the mobile station, thereby resuming the packet data service.

In addition, when the mobile station assigned the virtual IP address moves to a new PDSN area so that handoff between PDSNs is performed, a new PDSN receives information concerning the virtual IP address assigned to the mobile station from an old PDSN and registers the received information, thereby maintaining protocol through the virtual IP address.

In addition, when the mobile station assigned the virtual IP address moves to a new IWF area so that handoff between IWFs is performed, a new IWF receives information concerning the virtual IP address assigned to the mobile station from an old IWF and registers the received information, thereby maintaining protocol through the virtual IP address.

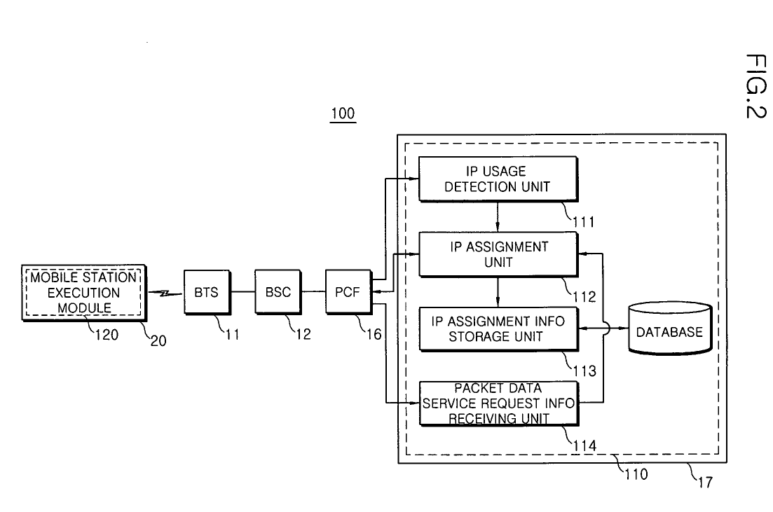

FIG. 2 is a block diagram of an IP address management system 100 in accordance with an embodiment of the present invention. The IP address management system 100 includes a PDSN execution module 110 configured in the form of software which can be run in the PDSN of the mobile communication system, and a mobile station execution module 120 configured in the form of software which can be run in the mobile station.

The PDSN execution module 110 includes an IP usage detection unit 111, an IP assignment unit 112, and an IP assignment info storage unit 113.

The IP usage detection unit 111 detects whether or not the mobile station 20 uses an actual IP address in a dormant state for a certain time period.

When the mobile station 20 assigned an IP address by the BSC 12 of a mobile communication system enters into a dormant state, the BSC 12 updates the IP address assigned to the mobile station 20 periodically. Accordingly, the time elapsed after entering into the dormant state can be calculated by counting the IP update period.

That is, the IP usage detection unit 111 detects whether or not the mobile station 20 uses an actual IP address in the dormant state for a certain time period by checking the number of times the BSC 20 of the mobile communication system updates the actual IP address assigned to the mobile station 20 after the mobile station 20 enters into the dormant state.

When the mobile station 20 is not determined to have used the actual IP address in the dormant state for the time period by the IP usage detection unit 111, the IP assignment unit 112 repossesses the actual IP address assigned to the mobile station 20 and assigns a virtual IP address for protocol maintenance.

At this time, information concerning the virtual IP address assigned by the IP assignment unit 112 is preferably transmitted to the mobile station 20 through an Overhead Message. That is, the IP assignment unit 112 adds information concerning the assigned virtual IP address to the Overhead Message, e.g., the (Extended) System Parameter Message, periodically transmitted from the mobile communication system to the mobile station 20, and transmits it to the mobile station 20 so that the mobile station 20 can be assigned the virtual IP address from the mobile communication system for protocol maintenance.

That is, if the mobile station 20 is assigned a virtual IP address, it means that since the mobile station 20 has been in the dormant state for a certain time period, the PDSN 17 repossessed an actual IP address from the mobile station 20.

Meanwhile, the IP assignment unit 112 may assign the repossessed actual IP address to a mobile station of a new user so that the new user can use data services using the assigned actual IP address.

The IP assignment info storage unit 113 stores and registers information concerning the IP address assigned by the IP assignment unit 112.

That is, when the actual IP address assigned to the mobile station by the IP assignment unit 112 is repossessed and a virtual IP address is assigned to the mobile station, the IP assignment info storage unit 113 stores information concerning the assigned IP address in a database.

Accordingly, when the mobile station 20 does not use an IP address in a dormant state for a certain time period, the PDSN 17 repossesses the IP address, thereby preventing waste of IP address resources.

Meanwhile, the IP address management system 100 in accordance with an embodiment of the present invention may further include a packet data service request info receiving unit 114. This is configured to allow the mobile station 20 assigned a virtual IP address to use packet data services again. The packet data service request info receiving unit 114 receives a packet data service request from the mobile station 20 assigned the virtual IP address.

The PDSN 17 having received the packet data service request through the packet data service request info receiving unit 114 repossesses the virtual IP address assigned to the mobile station 20 through the IP assignment unit 112 and assigns an actual IP address to the mobile station 20. At this time, the IP assignment unit 112 can transmit information concerning the assigned actual IP address to the mobile station 20 through an Overhead Message. Accordingly, the mobile station 20 can use packet data services again over socket communication using the actual IP address newly assigned.

Meanwhile, when the mobile station 20 assigned the virtual IP address moves to a new PDSN area such that a handoff process is performed between PDSNs, the IP assignment info storage unit 113 of the IP address management system 100 in accordance with an embodiment of the present invention preferably receives information concerning the virtual IP assigned to the mobile station 20 from the old PDSN and registers the received information.

That is, this is a configuration for performing handoff between PDSNs for the mobile station 20 assigned the virtual IP address. That is, when the mobile station 20 moves to a new PDSN area, the handoff between PDSNs is performed by the mobile communication system. In the handoff process, a new PDSN assigns a new IP address, instead of an old IP address assigned by the old PDSN, to the mobile station. At this time, if a virtual IP address is assigned, since the new PDSN does not possess information concerning an actual IP address assigned by the old PDSN, the new PDSN receives information concerning the assigned virtual IP address from the old PDSN, stores and registers it in a database, thereby maintaining the virtual IP address assigned to the mobile station 20. As a result, the protocol is maintained through the virtual IP address during the handoff process between the PDSNs.

Meanwhile, the time period counted to repossess the actual IP address assigned to the mobile station 20 may be selected from the user.

That is, as described above, the PDSN execution module 110 detects whether or not the mobile station 20 uses an actual IP address in a dormant state for a certain time period by monitoring through the IP usage detection unit 111 the number of times the BSC 12 of a mobile communication system updates the actual IP address assigned to the mobile station 20 after a predetermined time period in the dormant state of the mobile station 20. At this time, the time period counted to repossess the actual IP address assigned to the mobile station 20 may be selected from the user so that the time period can be varied for user's convenience. For this, the IP address management system 100 in accordance with an embodiment of the present invention further includes the mobile station execution module 120 that can be executed in the mobile station.

The mobile station execution module 120 returns an actual IP address in the dormant state of the mobile station 20, sets and transmits the time period counted to be assigned the virtual IP address to the PDSN execution module 110.

For example, the mobile station execution module 120 may provide a frequency menu that represents the use frequency of packet data services, such as ‘high’, ‘intermediate’, and ‘low’, to a user so that the user can select the use frequency of packet data services, and set the time period according to the use frequency selected from the user.

Accordingly, a user who frequently uses packet data services can set the time period to be long so that the number of times the actual IP address assigned to the mobile station is repossessed can be reduced. A user who uses packet data services less frequently can set the time period to be shorter so that the number of times the actual IP address assigned to the mobile station is repossessed can be increased. That is, the users can vary the number of times the actual IP address assigned to the mobile station is repossessed for their convenience.

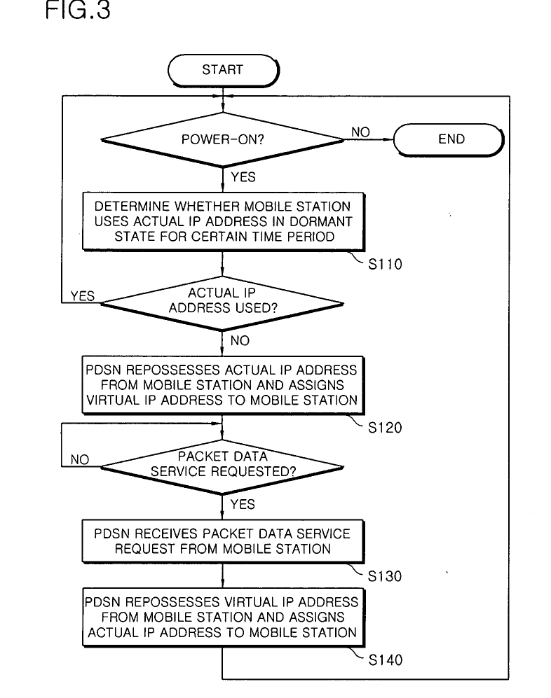

FIG. 3 is a flow chart of a method of managing an IP address assigned to a mobile station in accordance with an embodiment of the present invention.

According to the method of managing an IP address, in operation S110, it is determined whether or not a mobile station uses an actual IP address in a dormant state for a certain time period. At this time, a BSC of a mobile communication system determines whether or not the mobile station uses the actual IP address in the dormant state for a certain time period by monitoring the number of times the BSC updates the actual IP address assigned to the mobile station after a predetermined time period in the dormant state.

In operation S120, when the mobile station is not determined to have used the actual IP address in the dormant state for the time period in operation S110, the PDSN repossesses the actual IP address assigned to the mobile station and assigns a virtual IP address for protocol maintenance.

At this time, information concerning the virtual IP address assigned in operation S120 is preferably transmitted to the mobile station through an Overhead Message. The actual IP address repossessed in operation S120 can be assigned to a mobile station of a new user by the PDSN.

Accordingly, the present invention can prevent waste of IP address resources since an IP address not used by a mobile station is repossessed.

Meanwhile, according to another embodiment of the present invention, in operation 130, the PDSN receives a packet data service request from the mobile station assigned the virtual IP address. In operation 140, the PDSN repossesses the virtual IP address assigned to the mobile station in response to the packet data service request, and assigns an actual IP address to the mobile station so that the mobile station can use packet data services again.

In addition, according to the method of managing the IP address, when a mobile station assigned a virtual IP address through a handoff process (not shown) moves to a new PDSN area such that handoff is performed between PDSNs, the new PDSN receives from the old PDSN information concerning the virtual IP address assigned to the mobile station and registers the received information so that the mobile station can maintain the virtual IP address during the handoff process between the PDSNs.

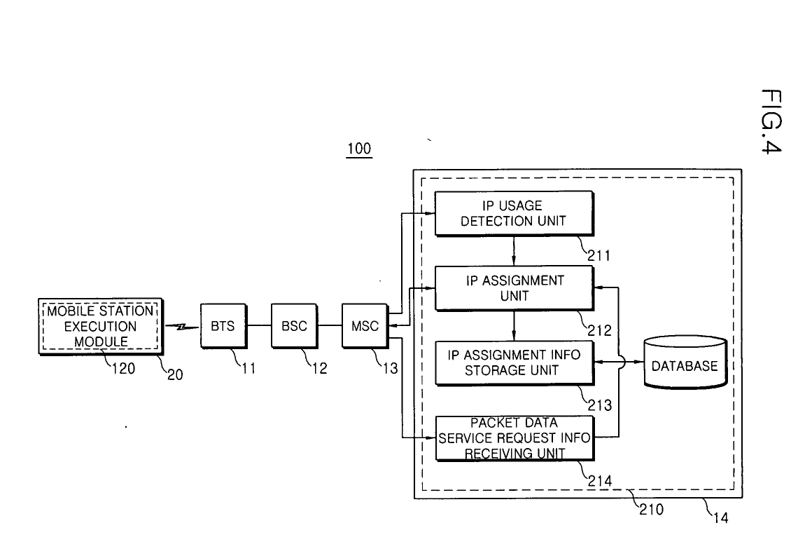

FIG. 4 is a block diagram of an IP address management system 100 in accordance with another embodiment of the present invention. The IP address management system 100 includes an IWF execution module 210 configured in the form of software which can be run in the IWF of the mobile communication system, and a mobile station execution module 220 configured in the form of software which can be run in the mobile station.

The IWF execution module 210 includes an IP usage detection unit 211, an IP assignment unit 212, and an IP assignment info storage unit 213.

The IP usage detection unit 211 detects whether or not the mobile station 20 uses an actual IP address in a dormant state for a certain time period.

When the mobile station 20 assigned an IP address by the BSC 12 of a mobile communication system enters into a dormant state, the BSC 12 updates the IP address assigned to the mobile station 20 periodically. Accordingly, the time elapsed after entering into the dormant state can be calculated by counting the IP update period.

That is, the IP usage detection unit 211 detects whether or not the mobile station 20 uses an actual IP address in the dormant state for a certain time period by checking the number of times the BSC 20 of the mobile communication system updates the actual IP address assigned to the mobile station 20 after the mobile station 20 enters into the dormant state.

When the mobile station 20 is not determined to have used the actual IP address in the dormant state for the time period by the IP usage detection unit 211, the IP assignment unit 212 repossesses the actual IP address assigned to the mobile station 20 and assigns a virtual IP address for protocol maintenance.

At this time, information concerning the virtual IP address assigned by the IP assignment unit 212 is preferably transmitted to the mobile station 20 through an Overhead Message. That is, the IP assignment unit 212 adds information concerning the assigned virtual IP address to the Overhead Message, e.g., the (Extended) System Parameter Message, periodically transmitted from the mobile communication system to the mobile station 20, and transmits it to the mobile station 20 so that the mobile station 20 can be assigned the virtual IP address from the mobile communication system for protocol maintenance.

That is, if the mobile station 20 is assigned a virtual IP address, it means that since the mobile station 20 has been in the dormant state for a certain time period, the IWF 14 repossessed an actual IP address from the mobile station 20.

Meanwhile, the IP assignment unit 212 may assign the repossessed actual IP address to a mobile station of a new user so that the new user can use data services using the assigned actual IP address.

The IP assignment info storage unit 213 stores and registers information concerning the IP address assigned by the IP assignment unit 212.

That is, when the actual IP address assigned to the mobile station by the IP assignment unit 212 is repossessed and a virtual IP address is assigned to the mobile station, the IP assignment info storage unit 213 stores information concerning the assigned IP address in a database.

Accordingly, when the mobile station 20 does not use an IP address in a dormant state for a certain time period, the IWF 14 repossesses the IP address, thereby preventing waste of IP address resources.

Meanwhile, the IP address management system 100 in accordance with an embodiment of the present invention may further include a packet data service request info receiving unit 214. This is configured to allow the mobile station 20 assigned a virtual IP address to use packet data services again. The packet data service request info receiving unit 214 receives a packet data service request from the mobile station 20 assigned the virtual IP address.

The IWF 14 having received the packet data service request through the packet data service request info receiving unit 214 repossesses the virtual IP address assigned to the mobile station 20 through the IP assignment unit 212 and assigns an actual IP address to the mobile station 20. At this time, the IP assignment unit 212 can transmit information concerning the assigned actual IP address to the mobile station 20 through an Overhead Message. Accordingly, the mobile station 20 can use packet data services again over socket communication using the actual IP address newly assigned.

Meanwhile, when the mobile station 20 assigned the virtual IP address moves to a new IWF area such that a handoff process is performed between IWFs, the IP assignment info storage unit 213 of the IP address management system 100 in accordance with an embodiment of the present invention preferably receives information concerning the virtual IP assigned to the mobile station 20 from the old IWF and registers the received information.

That is, this is a configuration for performing handoff between IWFs for the mobile station 20 assigned the virtual IP address. That is, when the mobile station 20 moves to a new IWF area, the handoff between IWFs is performed by the mobile communication system. In the handoff process, a new IWF assigns a new IP address, instead of an old IP address assigned by the old IWF, to the mobile station. At this time, if a virtual IP address is assigned, since the new IWF does not possess information concerning an actual IP address assigned by the old IWF, the new IWF receives information concerning the assigned virtual IP address from the old IWF, stores and registers it in a database, thereby maintaining the virtual IP address assigned to the mobile station 20. As a result, the protocol is maintained through the virtual IP address during the handoff process between the IWFs.

Meanwhile, the time period counted to repossess the actual IP address assigned to the mobile station 20 may be selected from the user.

That is, as described above, the IWF execution module 210 detects whether or not the mobile station 20 uses an actual IP address in a dormant state for a certain time period by monitoring through the IP usage detection unit 211 the number of times the BSC 12 of a mobile communication system updates the actual IP address assigned to the mobile station 20 after a predetermined time period in the dormant state of the mobile station 20. At this time, the time period counted to repossess the actual IP address assigned to the mobile station 20 may be selected from the user so that the time period can be varied for user's convenience. For this, the IP address management system 100 in accordance with an embodiment of the present invention further includes the mobile station execution module 220 that can be executed in the mobile station.

The mobile station execution module 220 returns an actual IP address in the dormant state of the mobile station 20, sets and transmits the time period counted to be assigned the virtual IP address to the IWF execution module 210.

For example, the mobile station execution module 220 may provide a frequency menu that represents the use frequency of packet data services, such as ‘high’, ‘intermediate’, and ‘low’, to a user so that the user can select the use frequency of packet data services, and set the time period according to the use frequency selected from the user.

Accordingly, a user who frequently uses packet data services can set the time period to be long so that the number of times the actual IP address assigned to the mobile station is repossessed can be reduced. A user who uses packet data services less frequently can set the time period to be shorter so that the number of times the actual IP address assigned to the mobile station is repossessed can be increased. That is, the users can vary the number of times the actual IP address assigned to the mobile station is repossessed for their convenience.

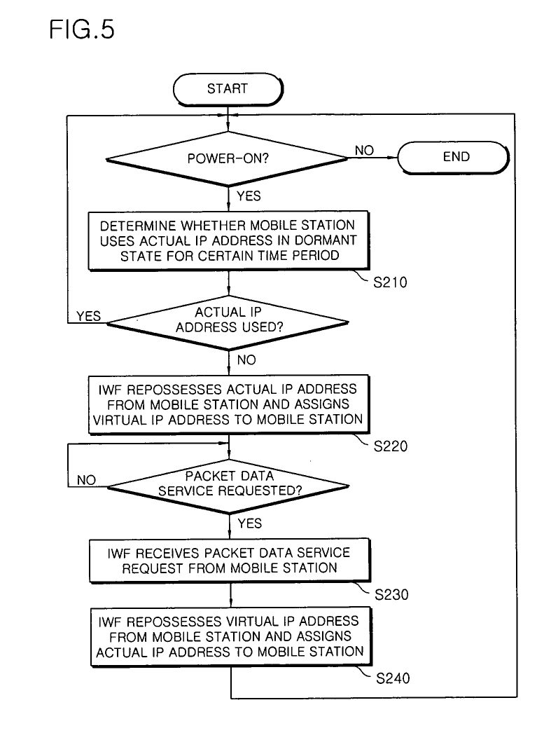

FIG. 5 is a flow chart of a method of managing an IP address assigned to a mobile station in accordance with another embodiment of the present invention.

According to the method of managing an IP address, in operation S210, it is determined whether or not a mobile station uses an actual IP address in a dormant state for a certain time period. At this time, a BSC of a mobile communication system determines whether or not the mobile station uses the actual IP address in the dormant state for a certain time period by monitoring the number of times the BSC updates the actual IP address assigned to the mobile station after a predetermined time period in the dormant state.

In operation S220, when the mobile station is not determined to have used the actual IP address in the dormant state for the time period in operation S210, the IWF repossesses the actual IP address assigned to the mobile station and assigns a virtual IP address for protocol maintenance.

At this time, information concerning the virtual IP address assigned in operation S220 is preferably transmitted to the mobile station through an Overhead Message. The actual IP address repossessed in operation S220 can be assigned to a mobile station of a new user by the IWF.

Accordingly, the present invention can prevent waste of IP address resources since an IP address not used by a mobile station is repossessed.

Meanwhile, according to another embodiment of the present invention, in operation 230, the IWF receives a packet data service request from the mobile station assigned the virtual IP address. In operation 240, the IWF repossesses the virtual IP address assigned to the mobile station in response to the packet data service request, and assigns an actual IP address to the mobile station so that the mobile station can use packet data services again.

In addition, according to the method of managing the IP address, when a mobile station assigned a virtual IP address through a handoff process (not shown) moves to a new IWF area such that handoff is performed between IWFs, the new IWF receives from the old IWF information concerning the virtual IP address assigned to the mobile station and registers the received information so that the mobile station can maintain the virtual IP address during the handoff process between the IWFs.

As apparent from the above description, according to the present invention, when a mobile station does not use an IP address in a dormant state for a certain time period, the IP address is repossessed and a virtual IP address is assigned to the mobile station. Subsequently, when the mobile station assigned the virtual IP address uses packet data services again, the virtual IP address is repossessed and an actual IP address is assigned to the mobile station so that packet data services can be resumed, thereby preventing waste of IP address resources. Further, when a handoff process is performed between PDSNs (or IWFs), a new PDSN (or IWF) receives information concerning the virtual IP address assigned to the mobile station from an old PDSN (or IWF) and registers the received information so that the mobile station can keep the virtual IP address during the handoff process between the PDSNs (IWFs).

While the present invention has been described with reference to exemplary embodiments thereof, it will be understood by those skilled in the art that various changes in form and details may be made therein without departing from the scope of the present invention as defined by the following claims.

What is claimed is:

1. A system for managing an IP (Internet Protocol) address assigned to a mobile station which can be executed in a PDSN (Packet Data Serving Node), wherein when the mobile station is not determined to have used an actual IP address in a dormant state for a certain time period, the actual IP address assigned to the mobile station is repossessed and a virtual IP address is assigned for protocol maintenance.

2. The system of claim 1, wherein when the system receives a packet data service request from the mobile station assigned the virtual IP address, the system repossesses the virtual IP address assigned to the mobile station and assigns an actual IP address to the mobile station.

3. The system of claim 1, wherein when the mobile station assigned the virtual IP address moves to a new PDSN area such that a handoff process is performed, a new PDSN located in the new PDSN area receives information concerning the virtual IP address assigned to the mobile station from an old PDSN and registers the received information.

4. A system for managing an IP address assigned to a mobile station including a PDSN execution module comprising:
an IP usage detection unit detecting whether or not a mobile station uses an actual IP address in a dormant state for a certain time period;
an IP assignment unit repossessing the actual IP address from the mobile station and assigning a virtual IP address to the mobile station for protocol maintenance when the mobile station is not determined to have used the actual IP address in the dormant state for a certain time period; and
an IP assignment info storage unit storing and registering information concerning the IP address assigned by the IP assignment unit in a database.

5. The system of claim 4, further comprising a packet data service request info receiving unit which receives a packet data service request from the mobile station assigned the virtual IP address, wherein the IP assignment unit further repossesses the virtual IP address assigned to the mobile station and assigns an actual IP address to the mobile station.

6. The system of claim 4, wherein when the mobile station assigned the virtual IP address moves to a new PDSN area such that a handoff process is performed between the PDSNs, the IP assignment info storage unit receives information concerning the virtual IP address assigned to the mobile station from an old PDSN and registers the received information.

7. The system of claim 4, wherein the I P usage detection unit detects whether or not the mobile station uses an actual IP address in a dormant state for a certain time period by monitoring the number of times a BSC (Base Station Controller) of a mobile communication system updates the actual IP address assigned to the mobile station in the dormant state of the mobile station after a predetermined time period.

8. The system of claim 7, wherein information concerning the virtual IP address assigned by the IP assignment unit is transmitted to the mobile station through an Overhead Message.

9. The system of claim 7, wherein the IP assignment unit further assigns the repossessed actual IP address to a mobile station of a new user.

10. The system of claim 7, wherein the time period counted to repossess the actual IP address assigned to the mobile station is selected by a user.

11. The system of claim 10, further comprising a mobile station execution module which sets the time period counted to assign the virtual IP address after repossessing the actual IP address in the dormant state of the mobile station, and transmits the set time period to the PDSN execution module.

12. The system of claim 11, wherein the mobile station execution module provides a frequency menu that represents the use frequency of packet data services to a user so that the user can select the use frequency of packet data services, and sets the time period according to the use frequency selected from the user.

13. A method of managing an IP address assigned to a mobile station, the method comprising the operations of:
determining whether or not a mobile station uses an actual IP address in a dormant state for a certain time period; and
repossessing the actual IP address assigned to the mobile station and assigning a virtual IP address for protocol maintenance by a PDSN when the mobile station is not determined to have used the actual IP address in the dormant state for the time period.

14. The method of claim 13, further comprising the operations of:
receiving, by the PDSN, a packet data service request from the mobile station assigned the virtual IP address; and
repossessing, by the PDSN, the virtual IP address assigned to the mobile station and assigning an actual IP address to the mobile station in response to the packet data service request.

15. The method of claim 13, further comprising receiving, by a new PDSN, information concerning the virtual IP address assigned to the mobile station from an old PDSN and registering the received information when the mobile station moves to a new PDSN area such that a handoff process is performed between the PDSNs.

16. The method of claim 13, wherein the operation of determining determines whether or not the mobile station uses the actual IP address in the dormant state for a certain time period by monitoring the number of times a BSC of a mobile communication system updates the actual IP address assigned to the mobile station after a predetermined time period in the dormant state of the mobile station.

17. The method of claim 16, wherein information concerning the virtual IP address assigned in the operation of repossessing the actual IP address and assigning a virtual IP address is transmitted to the mobile station through an Overhead Message.

18. The method of claim 16, wherein the repossessed actual IP address is assigned to a mobile station of a new user.

19. A system for managing an IP address assigned to a mobile station which can be executed in an IWF (InterWorking Function), wherein when the mobile station is not determined to have used an actual IP address in a dormant state for a certain time period, the actual IP address assigned to the mobile station is repossessed and a virtual IP address is assigned for protocol maintenance.

20. The system of claim 19, wherein when the system receives a packet data service request from the mobile station assigned the virtual IP address, the system repossesses the virtual IP address assigned to the mobile station and assigns an actual IP address to the mobile station.

21. The system of claim 19, wherein when the mobile station assigned the virtual IP address moves to a new IWF area such that a handoff process is performed, a new IWF located in the new IWF area receives information concerning the virtual IP address assigned to the mobile station from an old IWF and registers the received information.

22. A system for managing an IP address assigned to a mobile station including an IWF execution module comprising:
an IP usage detection unit detecting whether or not a mobile station uses an actual IP address in a dormant state for a certain time period;
an IP assignment unit repossessing the actual IP address from the mobile station and assigning a virtual IP address to the mobile station for protocol maintenance when the mobile station is not determined to have used the actual IP address in the dormant state for a certain time period; and
an IP assignment info storage unit storing and registering information concerning the IP address assigned by the IP assignment unit in a database.

23. The system of claim 22, further comprising a packet data service request info receiving unit which receives a packet data service request from the mobile station assigned the virtual IP address, wherein the IP assignment unit further repossesses the virtual IP address assigned to the mobile station and assigns an actual IP address to the mobile station.

24. The system of claim 22, wherein when the mobile station assigned the virtual IP address moves to a new IWF area such that a handoff process is performed between the IWFs, the IP assignment info storage unit receives information concerning the virtual IP address assigned to the mobile station from an old IWF and registers the received information.

25. The system of claim 22, wherein the IP usage detection unit detects whether or not the mobile station uses an actual IP address in a dormant state for a certain time period by monitoring the number of times a BSC of a mobile communication system updates the actual IP address assigned to the mobile station in the dormant state of the mobile station after a predetermined time period.

26. The system of claim 25, wherein information concerning the virtual IP address assigned by the IP assignment unit is transmitted to the mobile station through an Overhead Message.

27. The system of claim 25, wherein the IP assignment unit further assigns the repossessed actual IP address to a mobile station of a new user.

28. The system of claim 25, wherein the time period counted to repossess the actual IP address assigned to the mobile station is selected by a user.

29. The system of claim 28, further comprising a mobile station execution module which sets the time period counted to assign the virtual IP address after repossessing the actual IP address in the dormant state of the mobile station, and transmits the set time period to the IWF execution module.

30. The system of claim 29, wherein the mobile station execution module provides a frequency menu that represents the use frequency of packet data services to a user so that the user can select the use frequency of packet data services, and sets the time period according to the use frequency selected from the user.

31. A method of managing an IP address assigned to a mobile station, the method comprising the operations of:
determining whether or not a mobile station uses an actual IP address in a dormant state for a certain time period; and
repossessing the actual IP address assigned to the mobile station and assigning a virtual IP address for protocol maintenance by an IWF when the mobile station is not determined to have used the actual IP address in the dormant state for the time period.

32. The method of claim 31, further comprising the operations of:
receiving, by the IWF, a packet data service request from the mobile station assigned the virtual IP address; and
repossessing, by the IWF, the virtual IP address assigned to the mobile station and assigning an actual IP address to the mobile station in response to the packet data service request.

33. The method of claim 31, further comprising receiving, by a new IWF, information concerning the virtual IP address assigned to the mobile station from an old IWF and registering the received information when the mobile station moves to a new IWF area such that a handoff process is performed between the IWFs.

34. The method of claim 31, wherein the operation of determining determines whether or not the mobile station uses the actual IP address in the dormant state for a certain time period by monitoring the number of times a BSC of a mobile communication system updates the actual IP address assigned to the mobile station after a predetermined time period in the dormant state of the mobile station.

35. The method of claim 34, wherein information concerning the virtual IP address assigned in the operation of repossessing the actual IP address and assigning a virtual IP address is transmitted to the mobile station through an Overhead Message.

36. The method of claim 34, wherein the repossessed actual IP address is assigned to a mobile station of a new user.
